(19) United States
(12) Patent Application Publication
(10) Pub. No.: US 2021/0244124 A1
(43) Pub. Date: Aug. 12, 2021

(54) HEAD LAMP WITH COMFORTABLE BACK HEAD

(71) Applicant: Gichun KIM, Kwanmyung-city (KR)

(72) Inventor: Gichun KIM, Kwanmyung-city (KR)

(21) Appl. No.: 16/786,216

(22) Filed: Feb. 10, 2020

(51) Int. Cl. A42B 3/14; A42B 3/04; F21V 33/00; F21L 4/04

(52) U.S. Cl. CPC A42B 3/142; F21L 4/045; F21V 33/0008; A42B 3/0446

(57) ABSTRACT

The disclosed invention relates to a head lamp including a front main band and a rear main band present along the sagittal suture, wherein a front surface of the rear main band in contact with the back head of the user is concave. The head lamp has improved wearing comfort and reduced failure rate.

### TECHNICAL FIELD

The disclosure relates to a head lamp for illuminating a work site while wearing the lamp.

### BACKGROUND ART

A head lamp generally includes a headband member to be worn on the head of a user and a light member coupled to the front of the headband to illuminate a work site in front of the user.

The headband member is a part worn on the head of a user and may have a variety of forms.

First, there may be a bow-like curved headband which is continued forward and backward with reference to the sagittal suture of a user.

Second, there may be a ring type headband which is extended in right and left directions from the forehead of a user and connects with the back side of the head.

Third, there may be another ring type headband which is extended in right and left directions from the forehead of a user, connects with the back side of the head, and further includes a support band extending upward from both sides of the head and meeting at the top of the head or, otherwise, a support band extending upward from the forehead and the back of the head and meeting at the top of the head.

The present disclosure relates to a headlamp having a bow-like curved shape as described in the above first embodiment, wherein a headband in a bow-like curved shape is continued forward and backward along the sagittal suture of a user.

Such a headband is divided into a front main band and a rear main band, wherein the front and rear main bands move forward and backward and thus may be adjustable along a working range in order to match a size of the head.

The present disclosure proposes an optimum shape of the head lamp in aspects of user convenience and ease of manufacturing the same.

### DISCLOSURE

### Technical Problem

A rear main band in the conventional head lamp that includes a bow-like curved headband continued forward and backward with reference to the sagittal suture of a user wearing the head lamp, is formed in a bow shape starting from the top of the head and extending forward and backward in a circular arc form. Further, in order to stably fit the head lamp on the head when worn by the user, a rear support band extending in right and left directions in a bow shape is coupled at the bottom end of the rear main band.

Such a rear support band is helpful for ensuring stability in fitting the head lamp on the head when worn by the user. However, when both the front main band and the rear main band are tightened to narrow a gap therebetween in order to adjust the head lamp to match a size of the head, the support band may locally and heavily press a portion of the head, causing discomfort.

Further, providing and mounting the additional rear support band on the head lamp will increase the number of components during production, require a lot of work in assembly, and entail high failure rate.

### Technical Solution

In order to solve the problems described above, an object of the present disclosure is to provide a head lamp with configurations formed by: extending a part of the rear main band in right and left directions to enlarge an area while omitting a rear support band; and concavely forming the above area so that the back of the head (“back head”) of a user can be safely fitted therein.

### Advantageous Effects

The head lamp with the above configurations may have the following advantages. First, an area in contact with the back head fitted in a lower part of the rear main band in the head lamp may widely contact the back head of the user so as to support the same, thereby improving wearing comfort and stability. Second, the head lamp may be easily manufactured because of a simple structure without the rear support band. Third, failure rate is reduced due to no requirement of a coupler for the rear support band.

### DESCRIPTION OF DRAWINGS

FIG. 1 is a side view illustrating a state of wearing the conventional head lamp, which includes a main band to be fitted along the sagittal suture, on the head of a user.

FIG. 2 is a front-side perspective view illustrating the head lamp proposed in the present disclosure.

FIG. 3 is an exploded rear-side perspective view illustrating both of a front main band and a rear main band of the head lamp proposed in the present disclosure.

### BEST MODE

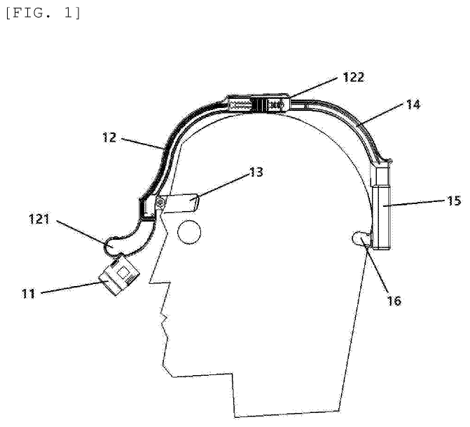

Hereinafter, configurations of the conventional head lamp will be briefly described with reference to FIG. 1.

A light source 11 is a device to receive electricity and emit light and may be hinge-coupled to the front end 121 of a front main band 12. The front main band 12 may be formed in an overall S-shape from the top of the head to a part coupled with a front support band 13, and then, extended in a J-shape and hinge-coupled with the light source 11 at the end of the J-shape. The front support band 13 may be coupled at a starting portion of the J-shape and extend in a bow shape in right and left directions, while a rear main band 14 is inserted into a hole 122 on a rear part at which the S-shape starts. The rear main band 14 is formed in an overall smooth “>” shape in a side view and may include a battery box 15 provided on a lower part, wherein a rear support band 16 is coupled at the bottom of the battery box 15 and extends in a bow shape in right and left directions.

The front support band 13 may contact the forehead of the user while the rear support band 16 may contact a lower part of the back head, thereby facilitating safe fitting of the head lamp on the head of the user.

With respect of the head band, depending upon an insertion depth of the rear main band 15 into the hole 122 of the front support band 13, a distance between the front support band 13 and the rear support band 16 may vary and be adjusted to match a size of the head.

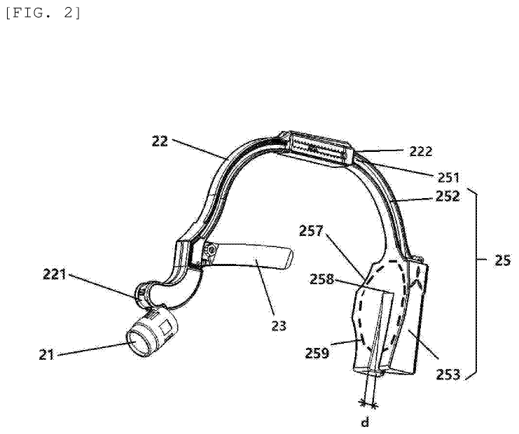

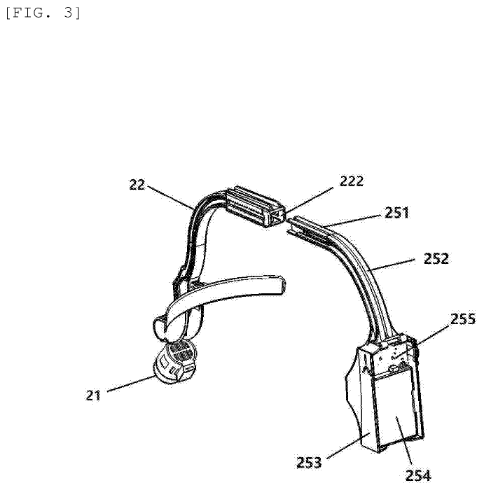

Hereinafter, embodiments of the present disclosure will be described in detail with reference to FIGS. 2 and 3.

FIG. 2 is a perspective view illustrating the head lamp proposed in the present disclosure. FIG. 3 is an exploded rear-side perspective view illustrating both a front main band and a rear main band in the head lamp proposed in the present disclosure. The description regarding from a light source 21 to the front main band 22 is substantially the same as that of the conventional head lamp.

The rear main band 25 is formed in an overall smooth “>” shape in a side view and may include: an insert member 251 provided on a front part, which is inserted into a hole 222 of the front main band 22 and adjusts a size of the head lamp; a movable member 252 starting from the rear end of the insert member 251 and extending in a circular arc form backward and downward; and a battery box 253 extending downward from the movable member 252. The battery box 253 is provided with a battery 254 to supply electricity to the light source 21 and a control member 255 to adjust electric current flowing from the battery to the light source 21.

A front surface 257 of the battery box 253 may generally have a diamond shape slightly longer in a vertical direction wherein right and left sides and the bottom side were cut out, and may be an overall concave and curved surface.

When the user wears the head lamp of the present disclosure on their head, the most concave part 258 of the front surface 257 may be located nearest the external occipital protuberance of the head without, however, being in direct contact with the same. The reason therefor is that the most concave part 258 is sufficiently deep as compared to a periphery part 259 [dotted part], and the periphery part 259 slightly spaced from the most concave part 258 may contact with the back head of the user. “d” in FIG. 2 is the depth of the most concave part. In this case, the widest protruding part in right and left directions in the front surface 257 is substantially a part horizontally extending from the most concave part 258.

Accordingly, as compared to the conventional head lamp including the rear support band 16 to support the lower part of the back head of the user, the head lamp with the above configurations may more widely support surroundings of the occipital protuberance of the user by the periphery part 259 in the front surface 257 of the rear main band 25, thereby accomplishing excellent wearing comfort and high stability.

The control member 255 may receive electric power from the battery 254, adjust electric current and supply electricity to the light source.

Consequently, the present embodiment has advantages over the conventional head lamp, including: improved wearing comfort at the front surface of the rear main band; high stability of the head lamp; and simple manufacturing process and reduction in failure rate owing to omission of a rear support band.

### DESCRIPTION OF REFERENCE NUMERALS

d: depth of the most concave part 258 in the front surface of the rear main band 25 according to the present embodiment

1. A head lamp, comprising:
a front main band and a rear main band present along a sagittal suture of a user, wherein the front main band is coupled with a front support band that extends in right and left directions in a middle of an overall length of the front main band, and is also coupled with the rear main band on a rear part such that the front main band and the rear main band are movable relative to each other,
wherein the rear main band includes: an insert member inserted into the front main band; a movable member extending from the insert member to a battery box; and the battery box extending from the movable member, and
wherein a front surface of the battery box is sufficiently concave and has a proper concave curvature such that, when the user wears the head lamp on their head, a most concave part in the front surface is located near a occipital protuberance of the user but is not in direct contact with the same, instead contacting surroundings of the occipital protuberance.

2. The head lamp according to claim 1, wherein the front surface of the battery box has a specific shape such that a horizontally widest part of the front surface is a part horizontally extending from the most concave part.
